(19) United States
(12) Patent Application Publication
(10) Pub. No.: US 2024/0127326 A1
(43) Pub. Date: Apr. 18, 2024

(54) BATTERY RENTAL MANAGEMENT DEVICE, BATTERY RENTAL MANAGEMENT METHOD, AND BATTERY RENTAL MANAGEMENT PROGRAM

(71) Applicant: HONDA MOTOR CO., LTD., Tokyo (JP)

(72) Inventors: Michiyo INOUE, Tokyo (JP); Kotaro NAKAMURA, Tokyo (JP); Hiroshi MORIYAMA, Tokyo (JP); Kentaro SUGIMURA, Saitama (JP)

(73) Assignee: HONDA MOTOR CO., LTD., Tokyo (JP)

(21) Appl. No.: 18/278,296

(22) PCT Filed: Feb. 22, 2021
(86) PCT No.: PCT/JP2021/006678

§ 371 Date: Aug. 22, 2023

(51) Int. Cl. G06Q 30/0645; G06F 21/31; G06F 21/44; G06Q 10/02

(52) U.S. Cl. CPC G06Q 30/0645; G06F 21/31; G06F 21/44; G06Q 10/02

(57) ABSTRACT

In a battery rental management device for controlling a battery storage apparatus provided in a predetermined management area where a worker works and configured to allow a battery to be rented to be attached and detached, in response to receiving a rental request for the battery which includes identification information of a desiring user, a storage unit configured to store identification information of an authorized user who has an authority to use the battery is referred to, and whether the desiring user is the authorized user is determined based on the identification information of the desiring user, and the desiring user is permitted to rent the battery based on a determination that the desiring user is the authorized user.

### TECHNICAL FIELD

The present invention relates to a battery rental management device, a battery rental management method, and a battery rental management program.

### BACKGROUND ART

Patent Literature 1 discloses a storage battery device which uses a storage battery for driving a power-assisted bicycle or an electric motorcycle, and not only charges the storage battery, but also supplies power of the storage battery to other devices.

### CITATION LIST

### Patent Literature

Patent Literature 1: JP2014-180914A

### SUMMARY OF INVENTION

### Technical Problem

A worker who works in a predetermined management area (for example, an apartment complex) may use an electric device driven by power in the work. Therefore, the worker sometimes brings a battery, which is a power source of the electric device, into the management area, which increases labor of the worker. In order to reduce such labor of the worker, it is conceivable that a battery is disposed in a management area in advance. In the related art, there is no disclosure of a technique for effectively utilizing a battery disposed in a management area in this way.

The present invention provides a battery rental management device, a battery rental management method, and a battery rental management program capable of appropriately increasing a chance of using a battery disposed in a predetermined management area where a worker works, thereby effectively utilizing the battery.

### Solution to Problem

A first invention is a battery rental management device for controlling a battery storage apparatus provided in a predetermined management area where a worker works and configured to allow a battery to be rented to be attached or detached, the battery rental management device including:
a determination unit configured to, in response to receiving a rental request for the battery which includes identification information of a desiring user who desires to use the battery, refer to a storage unit configured to store identification information of an authorized user who has an authority to use the battery, and determine whether the desiring user is the authorized user based on the identification information of the desiring user; and
a rental permission unit configured to permit the desiring user to rent the battery based on the determination unit determining that the desiring user is the authorized user, in which
the authorized user includes the worker and a resident who lives in the management area.

A second invention is a battery rental management method, in which:
a computer configured to control a battery storage apparatus provided in a predetermined management area where a worker works and configured to allow a battery to be rented to be attached and detached executes processes of:
   in response to receiving a rental request for the battery which includes identification information of a desiring user who desires to use the battery, referring to a storage unit configured to store identification information of an authorized user who has an authority to use the battery, and determining whether the desiring user is the authorized user based on the identification information of the desiring user; and
   permitting the desiring user to rent the battery based on a determination that the desiring user is the authorized user; and
the authorized user includes the worker and a resident who lives in the management area.

A third invention is a battery rental management program for causing a computer configured to control a battery storage apparatus provided in a predetermined management area where a worker works and configured to allow a battery to be rented to be attached and detached to execute processes of:
in response to receiving a rental request for the battery which includes identification information of a desiring user who desires to use the battery, referring to a storage unit configured to store identification information of an authorized user who has an authority to use the battery, and determining whether the desiring user is the authorized user based on the identification information of the desiring user; and
permitting the desiring user to rent the battery based on a determination that the desiring user is the authorized user, in which
the authorized user includes the worker and a resident who lives in the management area.

### Advantageous Effects of Invention

According to the present invention, a battery rental management device, a battery rental management method, and a battery rental management program capable of appropriately increasing a chance of using a battery disposed in a predetermined management area where a worker works, thereby effectively utilizing the battery can be provided.

### BRIEF DESCRIPTION OF DRAWINGS

FIG. 1 is a diagram illustrating an outline of a battery rental management method executed by a battery rental management device according to the present embodiment.

FIG. 2 is a diagram illustrating an example of a system configuration of a battery rental management system according to the present embodiment.

FIG. 3 is a diagram illustrating an example of an authorized user DB according to the present embodiment.

FIG. 4 is a diagram illustrating an example of a battery DB according to the present embodiment.

FIG. 5 is a diagram illustrating an example of a storage apparatus DB according to the present embodiment.

FIG. 6 is a diagram illustrating an example of a reservation information DB according to the present embodiment.

FIG. 7 is a flowchart of an example of the battery rental management method executed by the battery rental management device according to the present embodiment.

FIG. 8 is a flowchart of another example of the battery rental management method executed by the battery rental management device according to the present embodiment.

FIG. 9 is a diagram illustrating an example of a reservation information display screen displayed on a terminal of a desiring user or the like.

FIG. 10 is a diagram illustrating an example of a notice prompting a return of a battery displayed on a terminal of a resident.

FIG. 11 is a diagram illustrating an example of a situation in which a battery storage apparatus according to the present embodiment supplies power of the battery to a power supply target provided in a management area when a failure occurs.

### DESCRIPTION OF EMBODIMENTS

Embodiments of a battery rental management device, a battery rental management method, and a battery rental management program of the present invention will be described below with reference to the accompanying drawings.

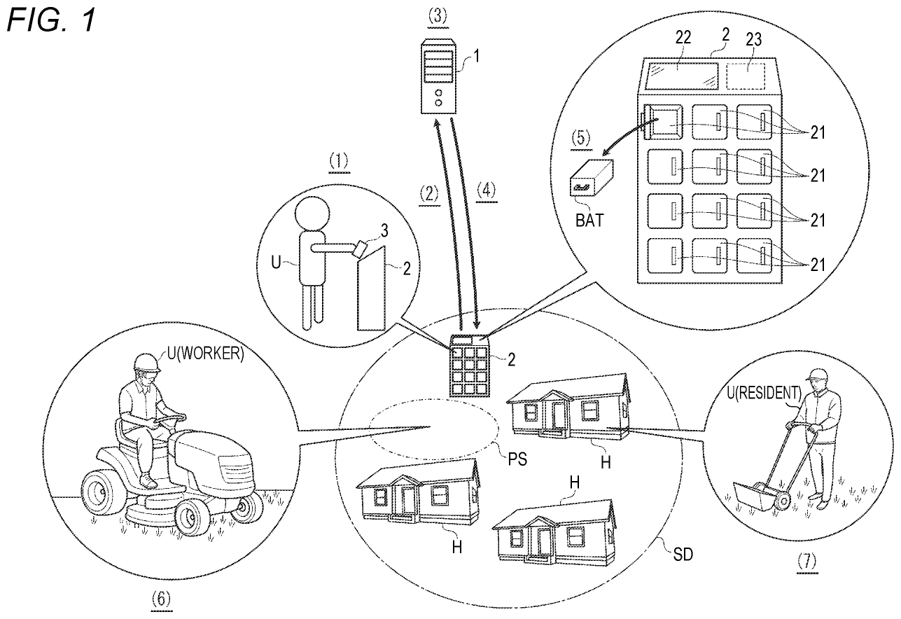

In FIG. 1, a management area SD is an apartment complex having a plurality of houses (residences) H in which residents live, and public spaces PS (for example, lawn squares) which can be used by the residents of houses H. In some cases, a worker (for example, a landscaper) requested by an administrator of the management area SD periodically goes to the management area SD to maintain the public space PS (for example, mowing the lawn) for landscape maintenance or the like. In general, the worker brings a device such as a lawn mower to be used for work into the management area SD. If the device is an electric device driven by power, the worker also needs to bring a battery, which is a power source, into the management area SD, which is troublesome.

From a viewpoint of reducing such labor for the worker, it is conceivable that a battery which can be used by the worker is disposed in advance in the management area SD. In this case, if only the worker can use the battery, the battery will be used only during a limited working time slot of the worker, and there is room for improvement from a viewpoint of effective utilization of the battery.

Therefore, in the present embodiment, a battery is disposed in a management area where a worker works, so that the battery is effectively utilized by appropriately increasing a chance of using the battery disposed in the management area while reducing labor of the worker who brings the battery into the management area.

In FIG. 1, a battery rental management device 1 is a computer which controls a battery storage apparatus 2 described later. An example of the battery rental management device 1 is a server device which can communicate with the battery storage apparatus 2, but the present invention is not limited thereto. For example, the battery rental management device 1 may be provided integrally with the battery storage apparatus 2.

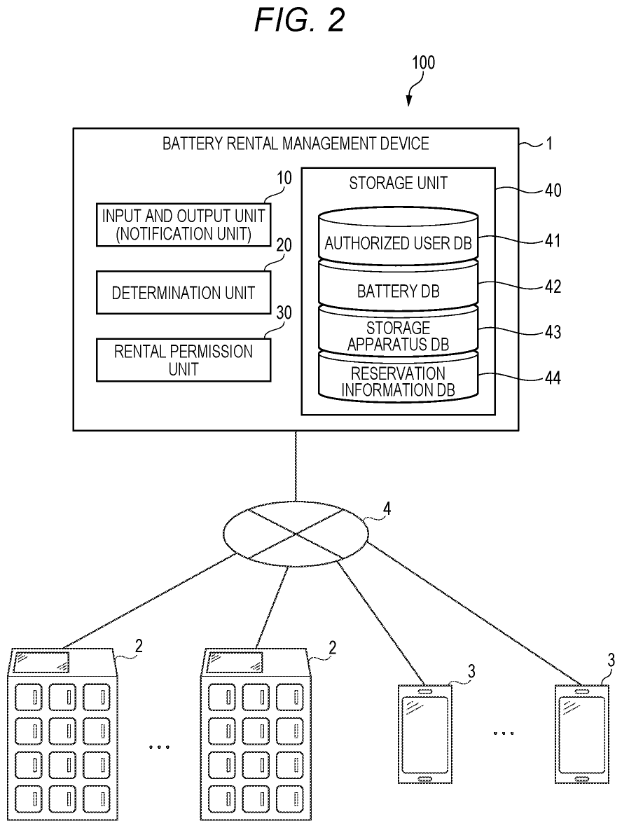

The battery rental management device 1 is configured to be able to refer to a storage unit (for example, reference numeral 40 in FIG. 2) which stores identification information of an authorized user who has an authority to use a battery BAT of the battery storage apparatus 2. Here, the authorized user includes a worker who works in the management area SD and a resident who lives in the management area SD. The worker who works in the management area SD is, for example, a person who receives a request from an administrator of the management area SD and performs work such as maintenance of the public space PS in the management area SD. The resident who lives in the management area SD is, for example, a resident of the house H present in the management area SD.

For example, in the above-described storage unit, identification information corresponding to the worker who works in the management area SD and the resident who lives in the management area SD is stored in advance as the identification information of the authorized user. The storage unit may be provided in a state in which the battery rental management device 1 can appropriately refer to the storage unit, and may be provided inside the battery rental management device 1 or provided outside the battery rental management device 1.

The battery storage apparatus 2 is provided in the management area SD and is configured to allow the battery BAT to be rented to be attached and detached. The battery BAT is a power storage device which is removed from the battery storage apparatus 2 and mounted in an electric device such as a lawn mower to function as a power source for driving the electric device. The battery BAT is, for example, a secondary battery such as a lithium ion battery or a nickel-metal hydride battery. The battery storage apparatus 2 is configured to be able to be driven by, for example, the battery BAT mounted in the battery storage apparatus 2 as a power source, and is also configured to be able to be driven by another power source (for example, a commercial power source CP described later).

For example, the battery storage apparatus 2 includes a housing space 21 capable of housing the battery BAT. As an example, in the present embodiment, as illustrated in FIG. 1, the battery storage apparatus 2 includes twelve housing spaces 21 each capable of housing one battery BAT. These twelve housing spaces 21 are assigned, for example, identification numbers 1 to 12 in order from the housing space 21 in an upper left row to the housing space 21 in a lower right row.

Each housing space 21 includes a door with a lock mechanism which can be closed while the battery BAT is housed. The door of each the housing space 21 is usually locked by the lock mechanism, and is opened under control of the battery storage apparatus 2 only when the battery rental management device 1 permits the battery BAT to be rented (described later). That is, the battery BAT can be removed from the battery storage apparatus 2 only when the battery rental management device 1 permits the battery BAT to be rented.

Each the housing space 21 includes a terminal (not illustrated) electrically connected to the battery BAT housed therein. The battery storage apparatus 2 can charge the battery BAT housed in each the housing space 21 and communicate with a control IC of the battery BAT (hereinafter, also referred to as the battery IC) housed in each the housing space 21 via the terminal of each the housing space 21. The battery storage apparatus 2 can communicate with the battery IC to acquire, from the battery IC, identification information of the battery BAT (for example, a battery ID described later), and information such as output voltage and remaining capacity (hereinafter, also referred to as battery information). The battery storage apparatus 2 may transmit the acquired battery information to a predetermined destination (for example, the battery rental management device 1).

Further, the battery storage apparatus 2 includes a display unit 22 for displaying various kinds of information to a desiring user who desires to use the battery BAT, and a communication unit 23 for communicating with a terminal 3 of the desiring user by short-range wireless communication or the like. As an example, the display unit 22 is a liquid crystal display, and the communication unit 23 is a near field communication (NFC) reader. The terminal 3 is an electronic device including a storage device (storage medium) which stores identification information of the desiring user (for example, a user ID described later), and is, for example, a smartphone. The terminal 3 may be an IC card or the like.

[Example of Flow Until Desiring User Uses Battery in Battery Storage Apparatus]

Here, an example of a flow until a desiring user U who desires to use the battery BAT uses the battery BAT housed in the battery storage apparatus 2 in the management area SD will be described. Here, the desiring user U is a worker who works in the management area SD or a resident who lives in the management area SD, and is an authorized user who has an authority to use the battery BAT housed in the battery storage apparatus 2 in the management area SD.

First, the desiring user U holds his/her own terminal 3 over the battery storage apparatus 2 (see (1) in FIG. 1). The battery storage apparatus 2 communicates with the held terminal 3 via the communication unit 23 and acquires the identification information of the desiring user U stored in the terminal 3. Then, the battery storage apparatus 2 transmits a rental request for the battery BAT (hereinafter, simply referred to as the rental request) including the acquired identification information of the desiring user U to the battery rental management device 1 (see (2) in FIG. 1). The battery storage apparatus 2 transmits, for example, the rental request which further includes identification information of the own device (for example, a storage apparatus ID described later) to the battery rental management device 1. Accordingly, even if there are a plurality of battery storage apparatuses 2, the battery rental management device 1 can identify the battery storage apparatus 2 which is a rental request transmission source.

The battery rental management device 1, in response to receiving the rental request in this way, refers to the above-described storage unit and determines whether the desiring user U is the authorized user based on the identification information of the desiring user U included in the received rental request (see (3) of FIG. 1). Specifically, the battery rental management device 1 determines whether the desiring user U is the authorized user by confirming whether the identification information of the authorized user stored in the storage unit includes identification information which matches the identification information of the desiring user U. As described above, in the example described here, since the desiring user U is the authorized user, the battery rental management device 1 determines that the desiring user U is the authorized user.

The battery rental management device 1 permits the desiring user U to rent the battery BAT based on the determination that the desiring user U is the authorized user. For example, the battery rental management device 1 instructs the battery storage apparatus 2, which is the rental request transmission source, to open the door of the housing space 21 in which the battery BAT to be rented to the desiring user U is stored (see (4) of FIG. 1). The battery storage apparatus 2 opens the door of the housing space 21 according to the instruction from the battery rental management device 1. Accordingly, the desiring user U can remove the battery BAT from the housing space 21 whose door is opened (see (5) in FIG. 1).

Therefore, as illustrated in (6) of FIG. 1, when the desiring user U is the worker who works in the management area SD, the desiring user U can drive an electric device such as a lawn mower by using the battery BAT removed from the battery storage apparatus 2 to perform a work such as maintenance of the public space PS. As illustrated in (7) of FIG. 1, when the desiring user U is the resident who lives in the management area SD, the desiring user U can drive a desired electric device with the battery BAT removed from the battery storage apparatus 2. In the example illustrated in (7) of FIG. 1, the desiring user U drives the own lawn mower with the battery BAT removed from the battery storage apparatus 2 to mow the lawn at home.

In the example described here, the desiring user U uses the terminal 3 to input own identification information to the battery storage apparatus 2, but the present invention is not limited thereto. For example, an input device such as a touch panel may be provided in the battery storage apparatus 2 in advance, and the desiring user U may input the own identification information to the battery storage apparatus 2 by operating the input device.

As described above, the battery rental management device 1 permits the worker who works in the management area SD and the resident who lives in the management area SD to rent the battery BAT of the battery storage apparatus 2 in the management area SD, so that it is possible to appropriately increase a chance of using the battery BAT while reducing labor of the worker who brings the battery BAT into the management area SD, thereby effectively utilizing the battery BAT.

Even if the battery BAT of the battery storage apparatus 2 in the management area SD can be used by an unspecified number of people, including the worker who works in the management area SD and a third party (for example, a person who lives outside the management area SD) other than the resident in the management area SD, it is also possible to further increase the chance of using the battery BAT. However, in this way, when the worker or the resident tries to use the battery BAT, a situation may arise in which the battery BAT is in use by a third party and cannot be used by the worker or the resident. If such a situation occurs, the work of the worker may be hindered, and benefits of the resident from providing the battery storage apparatus 2 in the management area SD may be diminished.

Therefore, it is desirable to limit the authorized users of the battery BAT of the battery storage apparatus 2 in the management area SD to the worker who works in the management area SD and the resident who lives in the management area SD. In this way, it is possible to prevent the occurrence of the situation in which when the worker or the resident tries to use the battery BAT of the battery storage apparatus 2 in the management area SD, the battery BAT is being used by a third party and cannot be used by the worker or the resident.

An example of a battery rental management system 100 to which the battery rental management device 1 and the battery storage apparatus 2 illustrated in FIG. 1 are applied will be described below. Hereinafter, the same components as those illustrated in FIG. 1 are denoted by the same reference numerals, and descriptions thereof will be omitted as appropriate.

[Battery Rental Management System]

As illustrated in FIG. 2, the battery rental management system 100 includes the battery rental management device 1 and the plurality of battery storage apparatuses 2. In the battery rental management system 100, the battery rental management device 1 and the plurality of battery storage apparatuses 2 are connected to communicate with each other via a network 4 such as the Internet. The battery rental management system 100 is a system for effectively utilizing the battery BAT stored in each battery storage apparatus 2 (that is, the battery BAT to be rented in each battery storage apparatus 2) under the control of the battery rental management device 1.

The plurality of battery storage apparatuses 2 are provided in different management areas. For example, as the management area SD illustrated in FIG. 1, each the management area where each of the battery storage apparatuses 2 is provided is an apartment complex having a plurality of houses in which each the resident lives and having a public space available to the resident of these houses. The worker regularly visits each of the management areas and performs work such as maintenance of the public space.

As illustrated in FIG. 2, in the battery rental management system 100, the battery rental management device 1 may be connected to a plurality of terminals 3 via the network 4 to be able to communicate with each other. The plurality of terminals 3 may be provided to be able to communicate with the battery storage apparatus 2 via the network 4, or may be provided to be able to communicate with the battery storage apparatus 2 by short-range wireless communication such as RFID without the network 4.

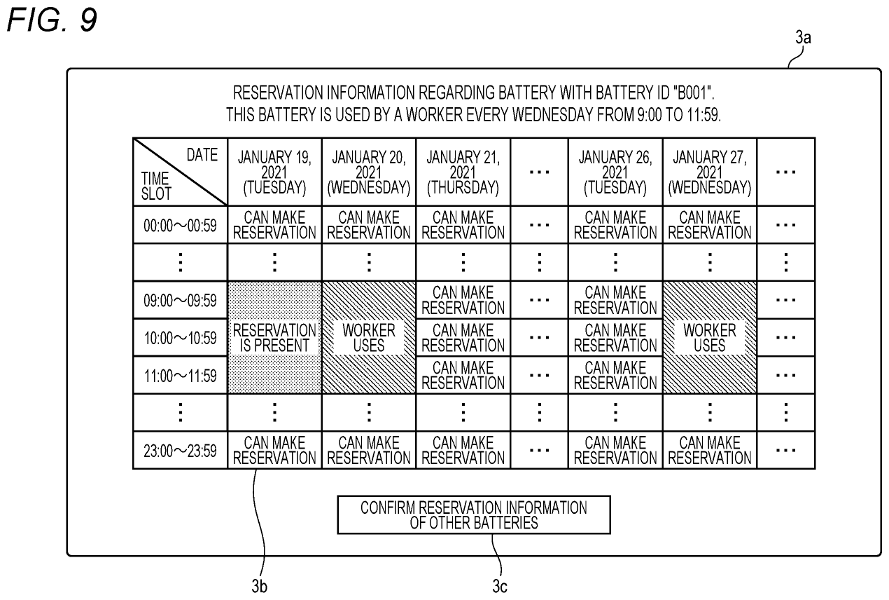

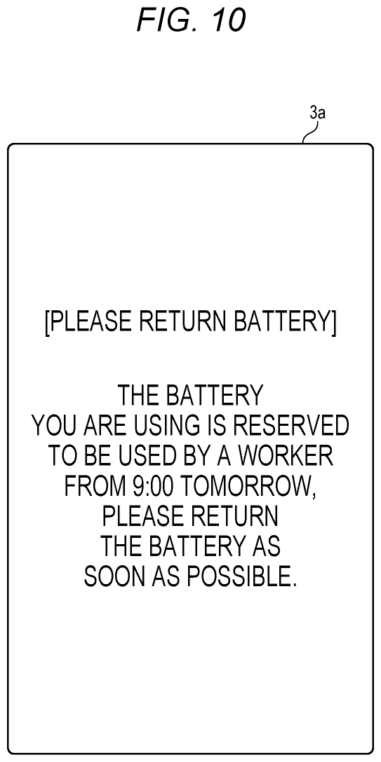

The plurality of terminals 3 are, for example, smartphones of the worker who works in each of the management areas and the resident who lives in each of the management areas, and store user IDs which represent identification information of the users (that is, the worker and the resident). The terminal 3 includes a display unit (for example, a liquid crystal display. See a reference numeral 3a in FIGS. 9 and 10) which displays various kinds of information to the user, and an input device (for example, a touch panel) for accepting user operations.

[Battery Rental Management Device]

The battery rental management device 1 is a server device (computer) including, for example, a processor, a storage device such as a memory or a hard disk, and an interface (none of which is illustrated) which controls input and output of data between the inside and the outside of the battery rental management device 1.

The battery rental management device 1 includes an input and output unit 10, a determination unit 20, a rental permission unit 30, and a storage unit 40. The storage unit 40 is implemented by, for example, a storage device such as a hard disk included in the battery rental management device 1, and stores an authorized user database (DB) 41, a battery DB 42, a storage apparatus DB 43, and a reservation information DB 44. These DBs are constructed in advance by an administrator or the like of the battery rental management device 1 and can be updated by the battery rental management device 1 as appropriate.

[Authorized User DB]

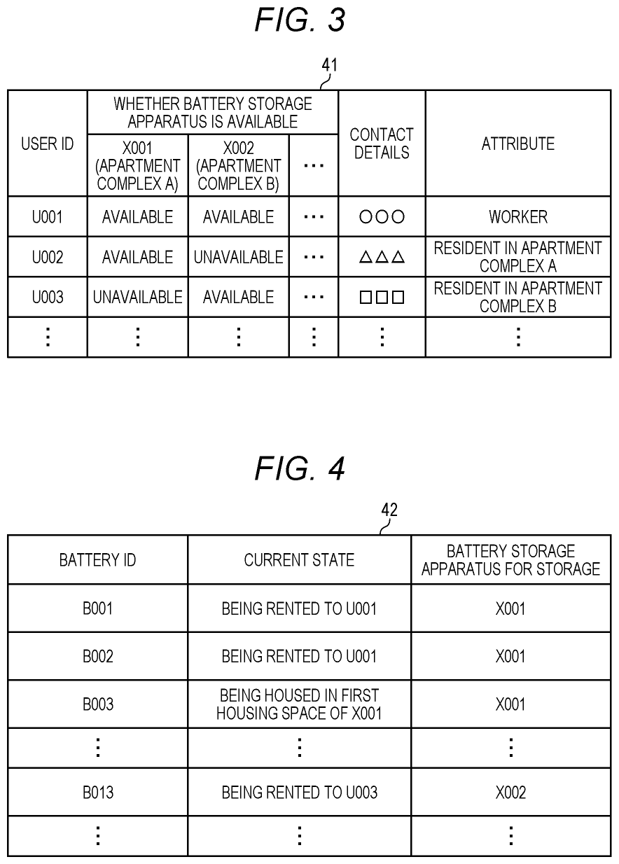

As illustrated in FIG. 3, the authorized user DB 41 stores information indicating the battery storage apparatuses 2 which can be used (or cannot be used) by each of the users in association with the user ID which individually identifies the worker who works in each of the management areas and the resident who lives in each of the management areas. For the sake of description, FIG. 3 also illustrates an attribute of each person corresponding to each user ID.

In FIG. 3, for example, a user ID “U001” is a user ID of a worker who works in an apartment complex A and an apartment complex B. In the user ID “U001”, both the battery storage apparatus 2 with the storage apparatus ID “X001” which is the battery storage apparatus 2 provided in the apartment complex A and the battery storage apparatus 2 with the storage apparatus ID “X002” which is the battery storage apparatus 2 provided in the apartment complex B are associated with information indicating “available”. This means that the worker with the user ID “U001” has an authority to use both the battery BAT of the battery storage apparatus 2 provided in the apartment complex A and the battery BAT of the battery storage apparatus 2 provided in the apartment complex B.

In FIG. 3, a user ID “U002” is a user ID of a resident in the apartment complex A. The user ID “U002” is associated with information indicating that only the battery storage apparatus 2 with the storage apparatus ID “X001” is “available”. This means that the resident with the user ID “U002” has an authority to use only the battery BAT of the battery storage apparatus 2 provided in the apartment complex A.

Similarly, in FIG. 3, a user ID “U003” is a user ID of a resident in the apartment complex B. The user ID “U003” is associated with information indicating that only the battery storage apparatus 2 with the storage apparatus ID “X002” is “available”. This means that the resident with the user ID “U003” has an authority to use only the battery BAT of the battery storage apparatus 2 provided in the apartment complex B.

Accordingly, in the present embodiment, the authorized user of the battery BAT of the battery storage apparatus 2 provided in the apartment complex A (hereinafter, simply referred to as the battery BAT of the apartment complex A) includes the worker who works in the apartment complexes A and B and the resident of the apartment complex A. In other words, a third party who lives outside the apartment complex A, such as the resident in the apartment complex B, is excluded from the authorized user of the battery BAT of the apartment complex A. Accordingly, it is possible to prevent the occurrence of the situation in which when the worker or the resident in the apartment complex A tries to use the battery BAT of the apartment complex A, the battery BAT is being used by the third party who lives outside the apartment complex A, and cannot be used by the worker or the resident in the apartment complex A.

Similarly, in the present embodiment, the authorized users of the battery BAT of the battery storage apparatus 2 provided in the apartment complex B (hereinafter, simply referred to as the battery BAT of the apartment complex B) are the worker who works in the apartment complexes A and B and the resident of the apartment complex B. In other words, a third party who lives outside the apartment complex B, such as the resident in the apartment complex A, is excluded from the authorized user of the battery BAT of the apartment complex B. Accordingly, it is possible to prevent the occurrence of the situation in which when the worker or the resident in the apartment complex B tries to use the battery BAT of the apartment complex B, the battery BAT is being used by the third party who lives outside the apartment complex B, and cannot be used by the worker or the resident in the apartment complex B.

The authorized user DB 41 may store information of contact details (for example, a telephone number and an email address of the terminal 3) of each person in association with each user ID, for example. Accordingly, the battery rental management device 1 can output various kinds of information via the input and output unit 10 to the desired contact details stored in the authorized user DB 41.

[Battery DB]

As illustrated in FIG. 4, the battery DB 42 stores information indicating a current state of each battery BAT and the battery storage apparatus 2 for storing each battery BAT in association with the battery ID which identifies each battery BAT.

In FIG. 4, for example, the battery ID “B001” is associated with information indicating that the current state is “being rented to U001”, and is associated with information indicating that the battery storage apparatus 2 for storage is “X001”. This indicates that the battery BAT with the battery ID “B001” is the battery BAT stored in the battery storage apparatus 2 with the storage apparatus ID “X001” (that is, the battery BAT in the apartment complex A), and is currently being rented to a person with the user ID “U001” (that is, the worker). On the other hand, the battery ID “B003” is associated with information indicating that the current state is “being housed in first housing space of X001”. This indicates that the battery BAT with the battery ID “B003” is currently being housed in the first housing space 21 of the battery storage apparatus 2 with the storage apparatus ID “X001” (that is, not being rented).

[Storage Apparatus DB]

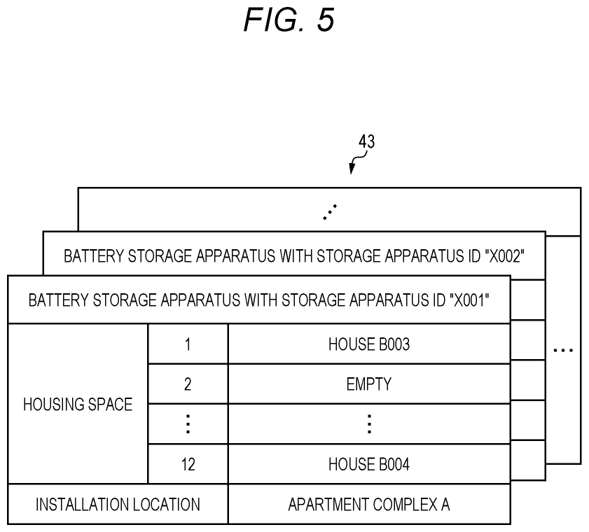

As illustrated in FIG. 5, the storage apparatus DB 43 stores information indicating the current state of each housing space 21 of the battery storage apparatus 2 in association with each battery storage apparatus 2. In an example illustrated in FIG. 5, information indicating that the current state of the first housing space 21 of the battery storage apparatus 2 with the storage apparatus ID “X001” is “being housed in B003” is stored, and information indicating that the current state of the second housing space 21 is “empty” is stored. The information indicates that the first housing space 21 of the battery storage apparatus 2 with the storage apparatus ID “X001” currently houses the battery BAT with the battery ID “B003”, and the second housing space 21 currently does not store any battery BAT. The storage apparatus DB 43 may further store installation location information indicating the management area where each the battery storage apparatus 2 is installed.

[Reservation Information DB]

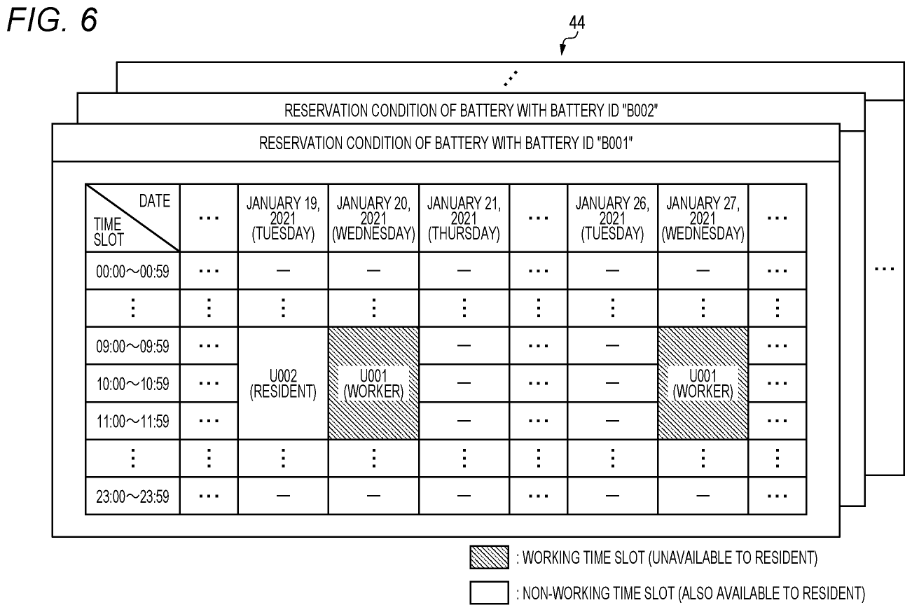

As illustrated in FIG. 6, the reservation information DB 44 stores, for each battery BAT, reservation information indicating a reservation condition of the battery BAT. The reservation information indicates, for example, whether there is a reservation for each time slot (for example, 1 hour width) for each date. In an example illustrated in FIG. 6, regarding the battery BAT with the battery ID “B001”, there are reservations for use by the worker (for example, the person with the user ID “U001”) from “09:00 to 11:59” on “Jan. 20, 2021 (Wednesday)” and “Jan. 27, 2021 (Wednesday)”, and there is a reservation for use by the person with the user ID “U002” (that is, the resident in the apartment complex A) for “09:00 to 11:59” on “Jan. 19, 2021 (Tuesday)”.

By the way, a working time slot of the worker in each management area is regular (for example, every Wednesday from 09:00 to 11:59). Therefore, in the reservation information DB 44, the reservation for the worker to use the battery BAT, that is, the reservation for the working time slot is automatically set, for example. On the other hand, in the reservation information DB 44, the reservation for the resident to use the battery BAT is set by, for example, the resident making a reservation request for the battery BAT to the battery rental management device 1 by using the terminal 3 or the like. This reservation is not limited to being performed by the terminal 3, and may be performed by using an input device such as a touch panel provided in the battery storage apparatus 2, for example.

[Each Functional Unit Included In Battery Rental Management Device]

The input and output unit 10 outputs various kinds of information to the battery storage apparatus 2 and the terminal 3 via the network 4 and receives various kinds of information from the battery storage apparatus 2 and the terminal 3. By outputting the various kinds of information to the battery storage apparatus 2 and the terminal 3, the input and output unit 10 can also function as a notification unit which notifies the worker and the resident of the information.

For example, when the terminal 3 of the desiring user is held up, each the battery storage apparatus 2 acquires the user ID, which is the identification information of the desiring user from the held terminal 3, and transmits, to the battery rental management device 1, a rental request for the battery BAT which includes the acquired user ID and the storage apparatus ID which is the identification information of the own device. The input and output unit 10 receives the rental request transmitted from the battery storage apparatus 2 in this manner.

The determination unit 20, in response to the reception of the rental request by the input and output unit 10, refers to the storage unit 40 and determines whether the desiring user is the authorized user based on the identification information of the desiring user included in the rental request. Specifically, the determination unit 20 refers to the user ID and storage apparatus ID included in the received rental request and the authorized user DB 41 to determine whether the desiring user is the authorized user.

For example, it is assumed that the user ID included in the rental request is “U001” and the storage apparatus ID included in the rental request is “X001”. As illustrated in FIG. 3, information indicating that the storage apparatus ID “X001” is “available” is associated with the user ID “U001” in the authorized user DB 41. Therefore, in this case, the determination unit 20 determines that the desiring user is the authorized user. Information indicating that the storage apparatus ID “X002” is also “available” is associated with the user ID “U001” in the authorized user DB 41. Therefore, when the user ID included in the rental request is “U001”, even if the storage apparatus 1D included in the rental request is “X002”, the determination unit 20 determines that the desiring user is the authorized user.

As illustrated in FIG. 3, the information indicating that only the storage apparatus ID “X001” is “available” is associated with the user ID “U002” in the authorized user DB 41. Therefore, in a case where the user ID included in the rental request is “U002”, when the storage apparatus ID included in the rental request is “X001”, the determination unit 20 determines that the desiring user is the authorized user. In other words, in a case where the user ID included in the rental request is “U002”, when the storage apparatus ID included in the rental request is one other than “X001”, the determination unit 20 determines that the desiring user is not the authorized user. Similarly, in a case where the user ID included in the rental request is “U003”, the determination unit 20 determines that the desiring user is the authorized user when the storage apparatus ID included in the rental request is “X002”, and determines that the desiring user is not the authorized user when the storage apparatus ID is another ID.

The rental permission unit 30 permits the desiring user to rent the battery BAT based on the determining that the desiring user is the authorized user by the determination unit 20. For example, when the determination unit 20 determines that the desiring user is the authorized user, the rental permission unit 30 determines the battery BAT to be rented to the desiring user. Then, the rental permission unit 30 transmits, to the battery storage apparatus 2 which is the rental request transmission source, an instruction to open the door of the housing space 21 in which the battery BAT to be rented to the desiring user is stored via the input and output unit 10, and then permits the desiring user to rent the battery BAT.

Specifically, the rental permission unit 30 refers to the battery DB 42 and the storage apparatus DB 43, and determines the battery BAT which is being stored in the battery storage apparatus 2 which is the rental request transmission source (that is, the battery BAT which is not being rented) as the battery BAT to be rented to the desiring user.

For example, it is assumed that the battery storage apparatus 2 which is the rental request transmission source is the battery storage apparatus 2 with the storage apparatus ID “X001” (that is, the storage apparatus ID included in the rental request is “X001”), and the contents stored in the storage apparatus DB 43 are as illustrated in FIG. 5. In this case, the rental permission unit 30 determines the battery BAT with the battery ID “B003” or a battery BAT with a battery ID “B004” as the battery BAT to be rented to the desiring user. For example, when the battery BAT with the battery ID “B003” is determined as the battery BAT to be rented to the desiring user, the rental permission unit 30 transmits, to the battery storage apparatus 2 with the storage apparatus ID “X001”, an instruction to open the door of the first housing space 21 in which the battery BAT is stored via the input and output unit 10.

When determining the battery BAT to be rented to the desiring user, the rental permission unit 30 may, for example, inquire of the battery storage apparatus 2, which is the rental request transmission source, about a remaining capacity (SOC: State Of Charge) of each battery BAT via the input and output unit 10, and determine the battery BAT with a highest remaining capacity (or the remaining capacity equal to or greater than a threshold) as the battery BAT to be rented to the desiring user. In this way, it is possible to prevent the battery BAT with a small remaining capacity from being rented to the desiring user.

By the way, if the battery BAT of the battery storage apparatus 2 is rented to the residents without restriction, when the worker tries to use the battery BAT of the battery storage apparatus 2, a situation may occur in which the resident is using the battery BAT and the worker cannot use the battery BAT (that is, the worker cannot work). In order to avoid such a situation from occurring, for example, when the desiring user is the resident, the rental permission unit 30 permits the resident to rent the battery BAT during a period other than the working time slot of the worker.

Specifically, the rental permission unit 30 refers to the reservation information DB 44 in which the reservation for the working time slot and the like is set, and determines a battery BAT which has no reservation (scheduled) to be used within a predetermined period of time (for example, 6 hours) as the battery BAT to be rented to the desiring user. Accordingly, the battery rental management device 1 can prevent the battery BAT from being unable to be rented according to the reservation set in the reservation information DB 44. The above predetermined period may be determined in consideration of a period for sufficiently charging battery BAT. In this way, when renting the reserved battery BAT, it is possible to prevent the battery with a low remaining capacity from being rented.

In the present embodiment, the resident who is the desiring user, for example, can perform a predetermined operation on his/her own terminal 3 or the like to make a reservation for using the battery BAT by causing the terminal 3 or the like to transmit a reservation request for the battery BAT which includes the user ID, which is his/her own identification information, to the battery rental management device 1. In this case, the input and output unit 10 receives the reservation request transmitted to the battery rental management device 1. The determination unit 20 determines that the desiring user is the authorized user when the user IDs stored in the authorized user DB 41 include the user ID which matches the user ID included in the reservation request received by the input and output unit 10. The rental permission unit 30 permits the resident who is the desiring user to rent the battery BAT by setting a reservation for the resident who is the desiring user to use the battery BAT in the reservation information DB 44 based on the determination that the desiring user is the authorized user in response to the reservation request.

In this case, with respect to the battery BAT which is reserved in the working time slot, the rental permission unit 30 can make a reservation of the resident who is the desiring user only for a time slot not included in the working time slot (illustrated as a non-working time slot in FIG. 6). That is, when the desiring user is the resident, the rental permission unit 30 permits the resident to rent the battery BAT during a period other than the working time slot of the worker.

Accordingly, by permitting the resident to rent the battery BAT on a condition that the time slot is a period other than the working time slot of the worker, the worker can be given the authority to use the battery BAT with priority over the resident. Therefore, it is possible to prevent a situation in which when the worker tries to use the battery BAT, the resident is using the BAT, and the worker cannot use the battery BAT (that is, the worker cannot work).

The rental permission unit 30 may prevent the resident from reserving at least the battery BAT for which the worker reserves within a predetermined period (for example, 6 hours) for that time slot. That is, when the desiring user is the resident, the rental permission unit 30 may permit the resident to rent the battery BAT during a period other than a time slot including the working time slot of the worker and a predetermined period before the working time slot. This predetermined period may be determined in consideration of the period for sufficiently charging the battery BAT.

Specifically, for example, it is assumed that the battery BAT with the battery ID “B001” is reserved for use by the worker during the time slot from “09:00 to 11:59” on “Jan. 20, 2021 (Wednesday)”. In this case, the battery rental management device 1 may prevent the resident from making a reservation for using the battery BAT with the battery ID “B001” during a time slot from “03:00 (that is, 6 hours before a start time of the working time slot) to 11:59” on “Jan. 20, 2021 (Wednesday)”.

In this way, by permitting the resident to rent the battery BAT during the period other than the time slot including the working time slot of the worker and the predetermined period before the working time slot, it is possible to prevent a situation in which the battery BAT cannot be rented to the worker as reserved, or prevent a battery BAT with a low remaining capacity from being rented to the worker. The worker may be allowed to use the battery BAT for a predetermined period of time before the above working time slot.

Each of function units, that is, each of the input and output unit 10, the determination unit 20, and the rental permission unit 30 can implement a function thereof by the processor of the battery rental management device 1 executing a program stored in advance in the storage device such as a hard disk, or by the interface of the battery rental management device 1, for example.

[Example of Battery Rental Management Method]

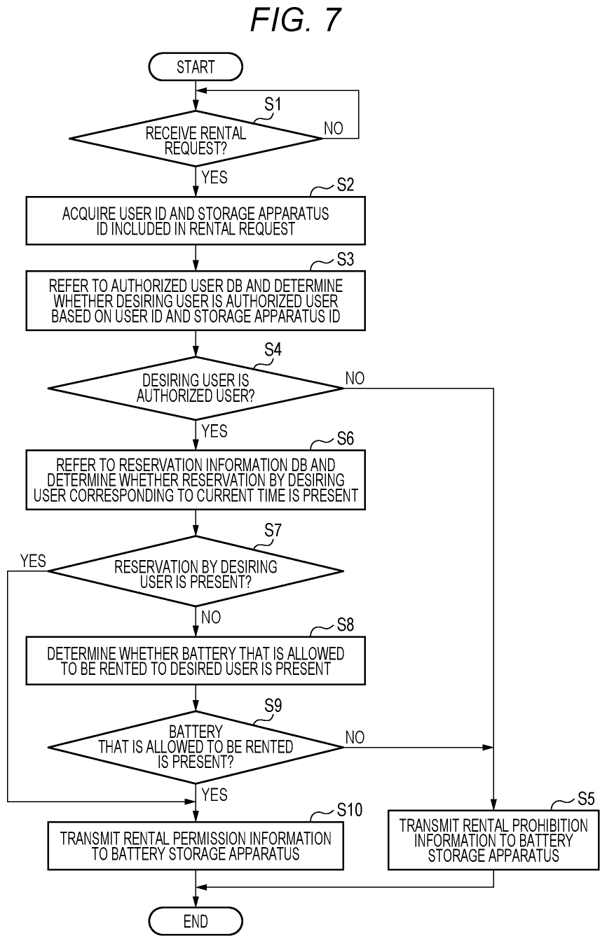

Next, an example of a battery rental management method executed by the battery rental management device 1 will be described with reference to FIG. 7. A battery rental management program which causes the battery rental management device 1 to execute the battery rental management method is stored in advance in, for example, a storage device (for example, the storage unit 40) of the battery rental management device 1.

First, the battery rental management device 1 waits until the battery rental management device 1 receives the rental request for the battery BAT from any of the battery storage apparatuses 2 via the network 4 (step S1; NO). When the rental request for the battery BAT is received (step S1; YES), the battery rental management device 1 acquires the user ID and the storage apparatus ID included in the rental request (step S2).

The battery rental management device 1 refers to the authorized user DB 41 and determines whether the desiring user is the authorized user based on the user ID and the storage apparatus ID acquired in step S2 (step S3).

As a result of the determination in step S3, when it is determined that the desiring user is not the authorized user (step S4; NO), the battery rental management device 1 transmits, to the battery storage apparatus 2 which is the rental request transmission source, rental prohibition information indicating that the battery BAT is not permitted to be rented via the network 4 (step S5), and ends the process. The battery storage apparatus 2 which receives the rental prohibition information does not open the door of the housing space 21 and displays, on the display unit 22, a message that the battery BAT cannot be rented, for example.

On the other hand, as a result of the determination in step S3, when it is determined that the desiring user is the authorized user (step S4; YES), the battery rental management device 1 refers to the reservation information DB 44 and determines whether a reservation by the desiring user corresponding to a current time is present (step S6). For example, when the desiring user is the resident “U002” and the current time is “09:00 on Jan. 19, 2021 (Tuesday)”, since the resident has the reservation for using the battery BAT (see FIG. 6), the battery rental management device 1 determines that the reservation by the desiring user corresponding to the current time is present.

As a result of the determination in step S6, when it is determined that the reservation by the desiring user is present (step S7; YES), since the battery BAT to be rented to the desiring user is determined at the time of reservation, the battery rental management device 1 directly proceeds to a process of step S10 as it is.

On the other hand, as a result of the determination in step S6, when it is determined that no reservation by the desiring user is present (step S7; NO), in order to determine the battery BAT to be rented to the desiring user, it is first determined whether a battery BAT which is allowed to be rented to the desiring user is present (step S8). In step S8, the battery rental management device 1, for example, determines that the battery BAT which is allowed to be rented is present when the battery BAT which is not currently being rented and is not reserved (scheduled) to be used within a predetermined period of time is present in the battery storage apparatus 2 which is the rental request transmission source. On the other hand, the battery rental management device 1 determines that no battery BAT which is allowed to be rented is present when the battery storage apparatus 2 which is the rental request transmission source does not have such a battery BAT.

As a result of the determination in step S8, when it is determined that no battery BAT which is allowed to be rented is present (step S9; NO), the battery rental management device 1 shifts to the process of step S5, transmits the rental prohibition information to the battery storage apparatus 2 which is the rental request transmission source, and ends the process.

On the other hand, as a result of the determination in step S8, when it is determined that the battery BAT which is allowed to be rented is present (step S9; YES), the battery rental management device 1 determines any battery BAT of the batteries BAT which are allowed to be rented as the battery BAT to be rented to the desiring user, transmits, to the battery storage apparatus 2 which is the rental request transmission source, the rental permission information indicating that the battery BAT is permitted to be rented via the network 4 (step S10), and ends the process. The rental permission information is, for example, information which instructs the opening of the door of the housing space 21 in which the battery BAT to be rented to the desiring user is housed. The battery storage apparatus 2 which receives the rental permission information opens the door of the housing space 21 according to the rental permission information, and displays a message to guide the housing space 21 with the door open on the display unit 22.

When it is determined in step S7 that the reservation by the desiring user is present, in step S10, the battery rental management device 1 may transmit the rental permission information for renting the battery BAT determined as the battery BAT to be rented to the desiring user at the time of reservation.

[Another Example of Battery Rental Management Method]

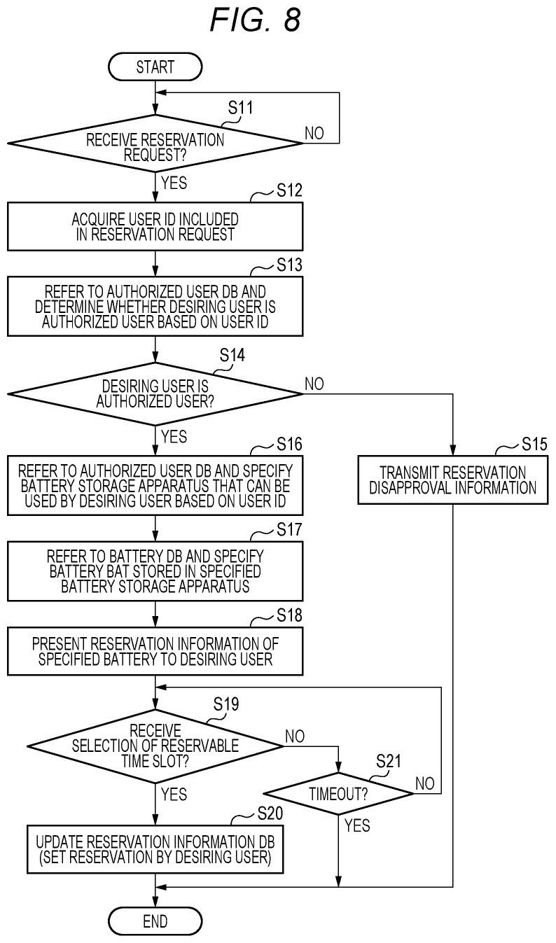

Next, another example of the battery rental management method executed by the battery rental management device 1 will be described with reference to FIG. 8. The battery rental management program which causes the battery rental management device 1 to execute the battery rental management method is stored in advance in a storage device (for example, the storage unit 40) of the battery rental management device 1 or the like. The battery rental management device 1 preferably executes both the battery rental management method illustrated in FIG. 7 and the battery rental management method illustrated in FIG. 8, but may execute only one of these two methods.

First, the battery rental management device 1 waits until the battery rental management device 1 receives a reservation request for the battery BAT from the terminal 3 or the like via the network 4 (step S11; NO). When the reservation request for battery BAT is received (step S11; YES), the battery rental management device 1 acquires the user ID included in the reservation request (step S12).

The battery rental management device 1 refers to the authorized user DB 41 and determines whether the desiring user is the authorized user based on the user ID acquired in step S12 (step S13). As a result of the determination in step S13, when it is determined that the desiring user is not the authorized user (step S14; NO), the battery rental management device 1 transmits, to the terminal 3 or the like which is a reservation request transmission source, reservation disapproval information indicating that the reservation for (that is, renting of) the battery BAT is not permitted via the network 4 (step S15), and ends the process. For example, the terminal 3 which receives the reservation disapproval information displays a message that the reservation for the battery BAT is disapproved on the display unit of the terminal 3.

On the other hand, as a result of the determination in step S13, when it is determined that the desiring user is the authorized user (step S14; YES), the battery rental management device 1 refers to the authorized user DB 41 and specifies the battery storage apparatus 2 which can be used by the desiring user based on the user ID acquired in step S12 (step S16). For example, when the user ID acquired in step S12 is “U002”, the battery storage apparatus 2 with the storage apparatus ID “X001” is specified in step S16 (see FIG. 3).

Then, the battery rental management device 1 refers to the battery DB 42 and specifies the battery BAT stored in the battery storage apparatus 2 specified in step S2 (step S17). For example, when the battery storage apparatus 2 with the storage apparatus ID “X001” is specified in step S16, the batteries BAT with the battery IDs “B001”, “B002”, “B003”, and the like are specified in step S17 (see FIG. 4). That is, by the process of step S17, for example, when the desiring user is the resident in the apartment complex A, the battery BAT in the apartment complex A is specified, and when the desiring user is the resident in the apartment complex B, the battery BAT in the apartment complex B is specified.

Then, the battery rental management device 1 transmits the reservation information about the battery BAT specified in step S17 to the terminal 3 or the like which is the reservation request transmission source via the network 4, thereby presenting the reservation information to the desiring user (step S18). An example of the reservation information display screen displayed on the terminal 3 or the like which is the reservation request transmission source by the process of step S18 will be described later with reference to FIG. 9.

Then, when the battery rental management device 1 receives selection of a reservable time slot by the desiring user via the reservation information display screen displayed on the terminal 3 or the like which is the reservation request transmission source (step S19; YES), the battery rental management device 1 updates the reservation information DB 44 to set the reservation for the time slot selected by the desiring user (step S20), and ends the process. On the other hand, when the selection of the reservable time slot is not received (step S19; NO) and timeout occurs after a certain period of time has elapsed (step S21; YES), the battery rental management device 1 ends the process as it is.

[Reservation Information Display Screen]

Next, an example of the reservation information display screen described above will be described with reference to FIG. 9. In the present example, the reservation information display screen presenting the reservation information of the battery BAT with the battery ID “B001” illustrated in FIG. 6 is displayed on the display unit 3a of the terminal 3 which is the reservation request transmission source. As illustrated in FIG. 9, on the reservation information display screen, in order to make it easier to know a time slot during which the worker has a reservation for using the battery BAT (that is, a reservation for the working time slot), a time slot during which the resident has a reservation for using the battery BAT, and a time slot during which no reservation is present, for example, these time slots are displayed using different colors.

The time slot during which no reservation is present is a time slot which can be reserved by the desiring user who requests the reservation. Therefore, for example, when the desiring user selects (for example, touches) a time slot 3b corresponding to “Jan. 19, 2021 (Tuesday) 23:00 to 23:59” illustrated in FIG. 9, the battery rental management device 1 sets, in the reservation information DB 44, reservation information for the desiring user requesting the reservation to use the battery BAT with the battery ID “B001” on “Jan. 19, 2021 (Tuesday) 23:00 to 23:59”.

The battery rental management device 1 includes the input and output unit 10 which causes the terminal 3 or the like which is the reservation request transmission source to display such a reservation information display screen by transmitting the reservation information to the terminal 3 or the like which is the reservation request transmission source. That is, the battery rental management device 1 includes the input and output unit 10 which functions as a notification unit which notifies the resident of the working time slot. Accordingly, the resident can know in advance the time slot during which the battery BAT cannot be used, and can make a reservation to use the battery BAT while taking this time slot into consideration. Therefore, it is possible to improve convenience for the resident.

As described above, in the case where the reservation for using the battery BAT can be made using an input device such as a touch panel provided in the battery storage apparatus 2, the reservation request transmission source is the battery storage apparatus 2. Therefore, in this case, the battery rental management device 1 may use the input and output unit 10 to transmit the reservation information to the battery storage apparatus 2 which is the reservation request transmission source to cause the display unit 22 of the battery storage apparatus 2 to display the reservation information display screen.

As illustrated in FIG. 9, the reservation information display screen also displays accompanying information such as “this battery is used by a worker every Wednesday from 9:00 to 11:59.” for the convenience of the desiring user. That is, the input and output unit 10 also functions as a notification unit which notifies the resident of the individual battery BAT used by the worker during the working time slot of the worker. Accordingly, the resident can know in advance which battery BAT cannot be used, and can make a reservation to use the battery BAT while taking this matter into consideration. Therefore, it is possible to improve convenience for the resident.

Further, the resident can, for example, touch a button 3c of “confirm reservation information of other batteries” displayed on the display unit 3a to confirm the reservation information of the other batteries BAT, similar to the reservation information of the battery BAT with the battery ID “B001”. Based on reservation information of the other batteries BAT, the input and output unit 10 can also notify the resident of the number of batteries used by the worker during the working time slot. Accordingly, the resident can know in advance the number of batteries BAT which cannot be used, and can make a reservation to use the battery BAT while taking this matter into consideration. Therefore, it is possible to improve convenience for the resident.

In addition, not limited to this, for example, the input and output unit 10 may transmit, to the terminal 3 or the like which is the reservation request transmission source, information indicating the individual battery BAT (for example, battery ID) used by the worker during the working time slot and the number of batteries BAT used by the worker during the working time slot to display the information directly on the terminal 3 or the like which is the reservation request transmission source. As an example, it is assumed that the worker uses a total of 10 batteries BAT with battery IDs “B001” to “B010” in the time slot from “09:00 to 11:59” on every Wednesday. In this case, the input and output unit 10 may transmit information representing the above matter to the terminal 3 or the like which is the reservation request transmission source to display “a total of 10 batteries with battery IDs ‘B001’ to ‘B010’ are used by a worker every Wednesday from 9:00 to 11:59” on the terminal 3 or the like.

[Battery Return Notice]

FIG. 10 is an example of a notification prompting the resident who uses the battery BAT scheduled to be used by the worker during the working time slot to return the battery displayed on the terminal 3 of the resident. In a case where the battery BAT scheduled to be used by the worker during the working time slot is being rented to the resident, when the battery BAT is not returned to the battery storage apparatus 2 until the start of the working time slot, the worker cannot use the battery BAT. When the battery BAT is returned just before the start of the working time slot, although the worker can use the battery BAT, it is conceivable that the battery BAT is not sufficiently charged and the remaining capacity is low.

Therefore, in a case where the battery BAT scheduled to be used by the worker during the working time slot is being rented to the resident, when a remaining time until the start of the working time slot becomes equal to or less than a predetermined threshold, the input and output unit 10 may notify the resident who is renting the battery BAT of returning the battery BAT For example, the input and output unit 10 transmits information for displaying a display screen prompting the resident who is renting the battery BAT scheduled to be used by the worker during the working time slot to return the battery BAT as illustrated in FIG. 10 on the terminal 3 of the resident. Accordingly, it is possible to prompt the resident to return the battery BAT, and prevent the situation in which the battery BAT is being used by the resident and the worker cannot use the battery BAT. The above threshold may be determined in consideration of a period for sufficiently charging the battery BAT. In this way, when the worker uses the battery BAT, it is possible to prevent the remaining capacity of the battery BAT from being low.

[Another Example of Battery Storage Apparatus]

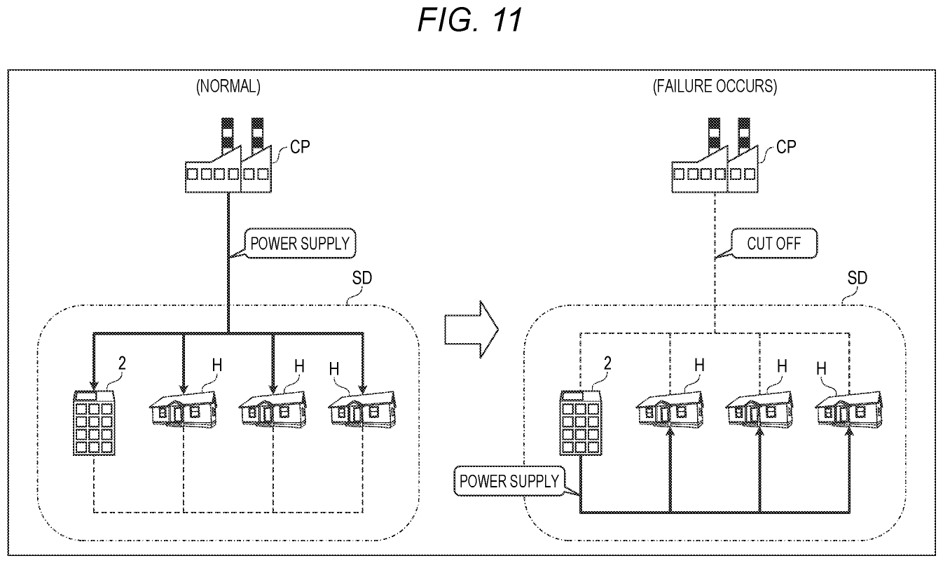

FIG. 11 is a conceptual diagram illustrating a situation in which the battery storage apparatus 2 illustrated in FIG. 1 supplies power of the mounted battery BAT (that is, the battery BAT housed in the housing space 21) to each house H in the management area SD. Normally, a commercial power source CP of an electric power company supplies power to the battery storage apparatus 2 and each house H within the management area SD. However, for example, it is assumed that a failure occurs in the commercial power source CP due to occurrence of a disaster or the like, and the power supply from the commercial power source CP to the management area SD is cut off.

Therefore, the battery storage apparatus 2 is configured to supply the power of the mounted battery BAT (that is, the battery BAT housed in the housing space 21) to each house H which is a power supply target and provided in the management area SD, the power of the mounted battery BAT may be supplied to these supply targets when the supply of the commercial power source CP to these supply targets is cut off. Accordingly, when the supply of the commercial power source CP to the supply target in the management area SD is cut off, the power of the battery BAT mounted in the battery storage apparatus 2 can be supplied to the supply target, and thus, the battery BAT mounted in the battery storage apparatus 2 can be used as an emergency power source. When the battery BAT is used as the emergency power source, the battery storage apparatus 2 may not rent out the battery BAT.

In the power supply from the battery storage apparatus 2 described above to the supply target, the battery storage apparatus 2 may start in accordance with an instruction from the battery rental management device 1 that detects a failure in the commercial power source CP, and the battery storage apparatus 2 that detects the cut-off of the power supply from the commercial power source CP may autonomously start.

As illustrated in FIG. 2, the battery rental management device 1 manages and controls the plurality of battery storage apparatuses 2. That is, the battery storage apparatuses 2 include a first battery storage apparatus and a second battery storage apparatus. The first battery storage apparatus is provided in a first management area and is configured to allow a first battery to be rented to be attached and detached, and the second battery storage apparatus is provided in a second management area and is configured to allow a second battery to be rented to be attached and detached.

In this case, when a rental request for the first battery is received, the determination unit 20 of the battery rental management device 1 determines whether the desiring user is a first authorized user who has an authority to use the first battery, and when a rental request for the second battery is received, the determination unit 20 determines whether the desiring user is a second authorized user who has an authority to use the second battery.

The rental permission unit 30 of the battery rental management device 1 permits the desiring user to rent the first battery based on the determining that the desiring user is the first authorized user by the determination unit 20 in response to receiving the rental request for the first battery, and permits the desiring user to rent the second battery based on the determining that the desiring user is the second authorized user by the determination unit 20 in response to receiving the rental request for the second battery.

The worker is a person who works in the first management area and the second management area, the first authorized user includes the worker and a first resident who lives in the first management area, and a second authorized user includes the worker and a second resident who lives in the second management area. Accordingly, it is possible to prevent a situation in which the first battery is being used by a third party who lives outside the first management area and the first resident or the worker cannot use the first battery from occurring. Similarly, it is possible to prevent a situation in which the second battery is being used by a third party who lives outside the second management area and the second resident or the worker cannot use the second battery from occurring. The worker can use the first battery when working in the first management area and can use the second battery when working in the second management area, and thus, there is no need to bring a battery into each management area, and for example, when the worker continuously perform work in the first management area and work in the second management area, it is unnecessary to bring the first battery from the first management area to the second management area, and thus, it is possible to reduce the labor of returning the first battery to the first management area due to the shortage of the first battery in the first management area and after finishing the work in the second management area.

As described above, the embodiments of the present invention have been described, but the present invention is by no means limited to the above embodiments, and various modifications and replacements can be made without departing from the gist of the present invention.

For example, in the embodiments described above, the example in which the management area is the apartment complex, the desiring user other than the worker is the resident, the power supply target within the management area is a house (residence) has been described, but an application target of the present invention is not limited thereto.

In the embodiments described above, the example in which the battery storage apparatus 2 charges the battery BAT housed in the housing space 21 has been described, but the battery storage apparatus 2 may not have a charging function, and the battery BAT may be charged by a charger other than the battery storage apparatus 2.

In the present specification, at least the following matters are described. Although corresponding constituent elements or the like in the above-described embodiments are shown in parentheses, the present invention is not limited thereto.

(1) A battery rental management device (battery rental management device 1) for controlling a battery storage apparatus (battery storage apparatus 2) provided in a predetermined management area (management area SD, apartment complex A, apartment complex B) where a worker works and configured to allow a battery (battery BAT) to be rented to be attached and detached, the battery rental management device including:
a determination unit (determination unit 20) configured to, in response to receiving a rental request for the battery which includes identification information of a desiring user (desiring user U) who desires to use the battery, refer to a storage unit (storage unit 40, authorized user DB 41) configured to store identification information of an authorized user who has an authority to use the battery, and determine whether the desiring user is the authorized user based on the identification information of the desiring user; and
a rental permission unit (rental permission unit 30) configured to permit the desiring user to rent the battery based on the determination unit determining that the desiring user is the authorized user, in which
the authorized user includes the worker and a resident who lives in the management area.

According to (1), by disposing the battery in the management area in advance, there is no need for the worker to bring the battery from the outside of the management area to the management area to work in the management area, and thus, convenience of the worker can be improved. When the desiring user of the battery is the authorized user including the resident who lives in the management area in addition to the worker, the desiring user is permitted to rent the battery. Accordingly, it is possible to increase a chance of using the battery and to effectively utilize the battery, compared to a case where only the worker is the authorized user of the battery.

(2) The battery rental management device according to (1), in which
the rental permission unit is configured to permit the resident to rent the battery during a period other than a working time slot of the worker when the desiring user is the resident.

According to (2), since the resident is permitted to rent the battery during the period other than the working time slot of the worker, it is possible to prevent a situation in which the battery is being used by the resident and the worker cannot use the battery from occurring.

(3) The battery rental management device according to (2), further including;
a notification unit (input and output unit 10) configured to notify the resident of the working time slot.

According to (3), since the resident is notified of the working time slot, the resident can know in advance the time slot during which the battery BAT cannot be used, and can make a reservation to use the battery BAT while taking this time slot into consideration. Therefore, it is possible to improve convenience for the resident.

(4) The battery rental management device according to (2) or (3), in which:
the battery storage apparatus is configured to allow a plurality of the batteries to be attached and detached; and
the battery rental management device further includes a notification unit (input and output unit 10) configured to notify the resident of an individual battery used by the worker during the working time slot or the number of the batteries used by the worker during the working time slot.

According to (4), since the individual battery used by the worker during the working time slot or the number of the batteries used by the worker during the working time slot is notified to the resident, the resident can know in advance the individual battery or the number of the batteries which cannot be used, and can make a reservation to use the battery while considering the battery which cannot be used. Therefore, it is possible to improve convenience for the resident.

(5) The battery rental management device according to any one of (2) to (4), further including:
a notification unit (input and output unit 10) configured to, in a case where the battery scheduled to be used by the worker during the working time slot is being rented to the resident, notify the resident who is renting the battery scheduled to be used by the worker during the working time slot of returning the battery when a remaining time until a start of the working time slot becomes equal to or less than a threshold.

According to (5), in a case where the battery used by the worker is being rented to the resident, the resident is notified of returning the battery when the remaining time until the start of the working time slot becomes equal to or less than the threshold, and thus, it s possible to prevent the situation in which the battery is being used by the resident and the worker cannot use the battery from occurring.

(6) The battery rental management device according to any one of (2) to (5), in which
in a case where the desiring user is the resident, the rental permission unit is configured to permit the resident to rent the battery during a period other than a time slot including the working time slot and a predetermined period before the working time slot.

According to (6), by permitting the resident to rent the battery during the period other than the time slot including the working time slot of the worker and the predetermined period before the working time slot, it is possible to prevent the situation in which the battery cannot be rented to the worker as reserved, or prevent a battery with a low remaining capacity from being rented to the worker.

(7) The battery rental management device according to any one of (1) to (6), in which
the battery storage apparatus is configured to supply power of the mounted battery to a supply target provided in the management area, and supplies the power of the battery mounted in the battery storage apparatus to the supply target when supply of a commercial power source to the supply target is cut off.

According to (7), when the supply of the commercial power source to the supply target in the management area is cut off, the power of the battery mounted in the battery storage apparatus can be supplied to the supply target, and thus, the battery mounted in the battery storage apparatus can be used as an emergency power source.

(8) The battery rental management device according to any one of (1) to (7), in which:
the battery storage apparatus includes:
   a first battery storage apparatus provided in a first management area and configured to allow a first battery to be rented to be attached and detached; and
   a second battery storage apparatus provided in a second management area and configured to allow a second battery to be rented to be attached and detached:
the determination unit is configured to:
   determine whether the desiring user is a first authorized user who has an authority to use the first battery in response to receiving a rental request for the first battery; and
   determine whether the desiring user is a second authorized user who has an authority to use the second battery in response to receiving a rental request for the second battery;
the rental permission unit is configured to:
   permit the desiring user to rent the first battery based on determining that the desiring user is the first authorized user by the determination unit in response to receiving the rental request for the first battery, and
   permit the desiring user to rent the second battery based on determining that the desiring user is the second authorized user by the determination unit in response to receiving the rental request for the second battery;
the worker is a person who works in the first management area and the second management area
the first authorized user includes the worker and a first resident who lives in the first management area; and
the second authorized user includes the worker and a second resident who lives in the second management area.

According to (8), since the authorized user of the first battery to be rented in the first management area includes the first resident who lives in the first management area and the worker, a third party such as a person who lives outside the first management area (for example, the second resident) can be excluded from the authorized user of the first battery, and the situation in which the first battery is being used by the third party and the first resident or the worker cannot use the first battery can be prevented. Similarly, since the authorized user of the second battery to be rented in the second management area includes the second resident who lives in the second management area and the worker, a third party such as a person living outside the second management area (for example, the first resident) can be excluded from the authorized user of the second battery, and a situation in which the second resident or the worker cannot use the second battery because the second battery is being used by the third party can be prevented.

(9) A battery rental management method, in which:
a computer (battery rental management device 1) configured to control a battery storage apparatus (battery storage apparatus 2) provided in a predetermined management area (management area SD, apartment complex A, apartment complex B) area where a worker works and configured to allow a battery (battery BAT) to be rented to be attached and detached executes processes of:
   in response to receiving a rental request for the battery which includes identification information of a desiring user who desires to use the battery (step S1; YES, step S11; YES), referring to a storage unit configured to store identification information of an authorized user who has an authority to use the battery, and determining whether the desiring user is the authorized user based on the identification information of the desiring user (step S3, step S13); and
   permitting the desiring user to rent the battery based on a determination that the desiring user is the authorized user (step S11, step S20); and the authorized user includes the worker and a resident who lives in the management area.

According to (9), by disposing the battery in the management area in advance, there is no need for the worker to bring the battery from the outside of the management area to the management area to work in the management area, and thus, the convenience of the worker can be improved. When the desiring user of the battery is an authorized user of the battery including the resident in the management area and the worker in the management area, the desiring user is permitted to rent the battery. Accordingly, it is possible to increase a chance of using the battery and to effectively utilize the battery, compared to a case where only the worker is the authorized user of the battery.

(10) A battery rental management program for causing a computer (battery rental management device 1) configured to control a battery storage apparatus (battery storage apparatus 2) provided in a predetermined management area (management area SD, apartment complex A, apartment complex B) area where a worker works and configured to allow a battery (battery BAT) to be rented to be attached and detached to execute processes of;
in response to receiving a rental request for the battery which includes identification information of a desiring user who desires to use the battery (step S1; YES, step S11: YES), referring to a storage unit configured to store identification information of an authorized user who has an authority to use the battery, and determining whether the desiring user is the authorized user based on the identification information of the desiring user (step S3, step S13); and
permitting the desiring user to rent the battery based on a determination that the desiring user is the authorized user (step S10, step S20), in which
the authorized user includes the worker and a resident who lives in the management area.

According to (10), by disposing the battery in the management area in advance, there is no need for the worker to bring the battery from the outside of the management area to the management area to work in the management area, and thus, the convenience of the worker can be improved. When the desiring user of the battery is an authorized user of the battery including the resident in the management area and the worker in the management area, the desiring user is permitted to rent the battery. Accordingly, it is possible to increase a chance of using the battery and to effectively utilize the battery, compared to a case where only the worker is the authorized user of the battery.

### REFERENCE SIGNS LIST

1 battery rental management device
2 battery storage apparatus
3 terminal
4 network
10 input and output unit (notification unit)
20 determination unit
30 rental permission unit
40 storage unit
41 authorized user DB

1. A battery rental management device for controlling a battery storage apparatus provided in a predetermined management area where a worker works and configured to allow a battery to be rented to be attached and detached, the battery rental management device comprising:
a determination unit configured to, in response to receiving a rental request for the battery which includes identification information of a desiring user who desires to use the battery, refer to a storage unit configured to store identification information of an authorized user who has an authority to use the battery, and determine whether the desiring user is the authorized user based on the identification information of the desiring user; and
a rental permission unit configured to permit the desiring user to rent the battery based on the determination unit determining that the desiring user is the authorized user, wherein
the authorized user includes the worker and a resident who lives in the management area.

2. The battery rental management device according to claim 1, wherein
the rental permission unit is configured to permit the resident to rent the battery during a period other than a working time slot of the worker when the desiring user is the resident.

3. The battery rental management device according to claim 2, further comprising:
a notification unit configured to notify the resident of the working time slot.

4. The battery rental management device according to claim 2, wherein:
the battery storage apparatus is configured to allow a plurality of the batteries to be attached and detached; and
the battery rental management device further comprises a notification unit configured to notify the resident of an individual battery used by the worker during the working time slot or the number of the batteries used by the worker during the working time slot.

5. The battery rental management device according to claim 2, further comprising:
a notification unit configured to, in a case where the battery scheduled to be used by the worker during the working time slot is being rented to the resident, notify the resident who is renting the battery scheduled to be used by the worker during the working time slot of returning the battery when a remaining time until a start of the working time slot becomes equal to or less than a threshold.

6. The battery rental management device according to claim 2, wherein
in a case where the desiring user is the resident, the rental permission unit is configured to permit the resident to rent the battery during a period other than a time slot including the working time slot and a predetermined period before the working time slot.

7. The battery rental management device according to claim 1, wherein
the battery storage apparatus is configured to supply power of the mounted battery to a supply target provided in the management area, and supplies the power of the battery mounted in the battery storage apparatus to the supply target when supply of a commercial power source to the supply target is cut off.

8. The battery rental management device according to claim 1, wherein:
the battery storage apparatus includes:
a first battery storage apparatus provided in a first management area and configured to allow a first battery to be rented to be attached and detached; and
a second battery storage apparatus provided in a second management area and configured to allow a second battery to be rented to be attached and detached;
the determination unit is configured to:
determine whether the desiring user is a first authorized user who has an authority to use the first battery in response to receiving a rental request for the first battery; and
determine whether the desiring user is a second authorized user who has an authority to use the second battery in response to receiving a rental request for the second battery;
the rental permission unit is configured to:
permit the desiring user to rent the first battery based on determining that the desiring user is the first authorized user by the determination unit in response to receiving the rental request for the first battery; and
permit the desiring user to rent the second battery based on determining that the desiring user is the second authorized user by the determination unit in response to receiving the rental request for the second battery;
the worker is a person who works in the first management area and the second management area;
the first authorized user includes the worker and a first resident who lives in the first management area; and
the second authorized user includes the worker and a second resident who lives in the second management area.

9. A battery rental management method, wherein:
a computer configured to control a battery storage apparatus provided in a predetermined management area where a worker works and configured to allow a battery to be rented to be attached and detached executes processes of:
in response to receiving a rental request for the battery which includes identification information of a desiring user who desires to use the battery, referring to a storage unit configured to store identification information of an authorized user who has an authority to use the battery, and determining whether the desiring user is the authorized user based on the identification information of the desiring user; and
permitting the desiring user to rent the battery based on a determination that the desiring user is the authorized user; and
the authorized user includes the worker and a resident who lives in the management area.

10. A non-transitory computer-readable storage medium storing a battery rental management program for causing a computer configured to control a battery storage apparatus provided in a predetermined management area where a worker works and configured to allow a battery to be rented to be attached and detached to execute processes of:
in response to receiving a rental request for the battery which includes identification information of a desiring user who desires to use the battery, referring to a storage unit configured to store identification information of an authorized user who has an authority to use the battery, and determining whether the desiring user is the authorized user based on the identification information of the desiring user; and
permitting the desiring user to rent the battery based on a determination that the desiring user is the authorized user, wherein
the authorized user includes the worker and a resident who lives in the management area.
